(19) United States
(12) Patent Application Publication
(10) Pub. No.: US 2011/0161892 A1
(43) Pub. Date: Jun. 30, 2011

(54) Display Interface and Method for Presenting Visual Feedback of a User Interaction

(75) Inventor: Hafid Hamadene, Forest Park, IL (US)

(73) Assignee: MOTOROLA-MOBILITY, INC., Libertyville, IL (US)

(21) Appl. No.: 12/978,608

(22) Filed: Dec. 26, 2010

Related U.S. Application Data
(60) Provisional application No. 61/290,766, filed on Dec. 29, 2009.

(51) Int. Cl. G06F 3/033

(52) U.S. Cl. 715/863

(57) ABSTRACT

A display interface and method for presenting visual feedback of a user interaction with an image being presented via an electronic device are provided. The display interface includes a display adapted for visually presenting to the user at least a portion of an image. The display interface further includes a user input adapted for receiving a gesture including a user interaction with the electronic device. The display interface still further includes a controller. The controller is adapted for associating the gesture with a function, determining whether the associated function has reached a limit which would preclude execution of the associated function, and executing the function associated with the detected gesture. If the associated function has not reached the limit which would preclude execution of the associated function, then controller is adapted for executing the function associated with the detected gesture. If the associated function has reached the limit which would preclude execution of the associated function, then the controller is adapted for producing an image distortion proximate the user interaction.

### FIELD OF THE INVENTION

The present invention relates generally to a device and a method for providing feedback via a display to the user of an electronic device, and more particularly, to providing visual feedback of receipt of a gesture, in instances where a function associated with the gesture has reached a limit which would preclude execution of the function.

### BACKGROUND OF THE INVENTION

Touch sensitive surfaces are increasingly becoming popular as interfaces for portable electronic devices, where the general trend for many devices is for an overall reduction in size. One of the challenges with reducing the overall size is the fact that there is a desire for the overall size reductions to take place without compromising or reducing the size of some of the user interface elements, such as screen size. In such instances, overall reductions in size without a corresponding reduction in some of the interface elements can only occur if some of the surface space of a device can be shared or can support multiple functions. For example, in some instances previously distinct portions of the surface of the device that separately supported user input or user output, have been merged such that the same surface that receives input from the user can also convey information or output to a user.

The use of touch sensitive surfaces or alternative forms of user input through gesturing has allowed more of the surface space to be used for supporting a larger display. In the case of touch sensitive surfaces, the interface surface can be configured to share the same space as the display. Such a sharing allows the user to interact with elements forming parts of a currently displayed image, which can be readily changed to accommodate different types of functions to be performed by the device. Such flexibility readily enables customized interfaces through a different displayed image, which enables the interface to better map to the current function intended to be performed by the device.

With the greater emergence of touch sensitive surfaces, gestures have emerged as an increasingly used interaction for purposes of interfacing with the displayed items and/or touch sensitive zones. In at least some cases, the different possible gestures can be received through the same shared surface space, where the particular movement associated with a particular gesture is distinguished from other different movements or different sequence of movements associated with a different particular gesture, which is applied to the same surface. In at least some instances the detected gesture can be relatively intuitive, where the interaction of the user through a pointer relative to the screen mimics the desired effect. For example, a sliding gesture along the surface could be used to indicate a desire to pan an image, or scroll through a list of items, where the image extends beyond the boundaries of the screen, or where the currently displayed elements from the list represents only a portion of the elements contained in the list. In such an instance, the touch sensitive surface tracks the movement of the pointer, such as a stylus or the user's finger at different points in time in order to determine the overall movement and/or traced pattern. The overall movement is then mapped to one of potentially multiple different predefined gestures, which upon detection can be used to invoke a corresponding function.

However there are times when it may be difficult to discern whether the intended gesture is being properly detected. With at least some forms of user input, the user will receive feedback as part of the user interaction. Many button types will provide a vibration, or will have a built in mechanical deformation that can provide the user a form of tactile feedback, which can be perceived by the user upon a successful actuation of the element. For example, the compression of a popple, which might be included in the overall structure of an actuatable button, can often be felt and/or heard by the user. In other instances, the device will actuate an audio and/or vibrational device upon the detection of a successful actuation of a user interface element. In still further instances, the feedback can be in the form of the execution of the intended function.

Because a gesture can be comprised of a sequence of multiple interactions, which might trace a discernable pattern, and because portions of a gesture can be reused as a part of other gestures, any feedback in the form of a sound or vibration which may be triggered as a part of a user interaction with the device may be the result of the detection of a portion of a gesture and not the complete intended gesture. As such, it may be unclear as to whether detected interaction represents the detection of a complete gesture or just a portion of the overall intended gesture. In other words, even though an interaction might trigger a form of feedback to the user, it may not always be clear whether the feedback represents the detection of the complete gesture corresponding to an intended function, or something less than the complete intended gesture, which might be mapped to an alternative unintended function. In other instances, there may not be any purposeful feedback relative to the successful detection of a gesture other than the performance of the associated function.

However in some cases the device may not be able to perform the requested function, even if the associated gesture was successfully detected by the device. Furthermore, it may not be readily apparent to the user that function can not be performed. Such an instance may occur where a limit has been reached relative to a requested function. For example, where the edge of a displayed image already coincides with the edge of the display, such as where there is no more image in a particular direction. Any further attempts to scroll the displayed image in that direction may not be possible. In such an instance, it may not be clear whether the gesture corresponding to the intended function has been properly detected. Alternatively, the user might assume that the lack of an immediate response may be due to a delay in the execution of the function due to a slow user interface and/or a slow processor or heavy processor load.

Correspondingly, the present inventors have recognized that it would be beneficial to provide an indication that the gesture associated with the desired function has been properly detected and that the device is unable to perform the function as requested, such as due to the interface being at a boundary condition which precludes the function being performed in the requested direction and/or as expected by the user.

### SUMMARY OF THE INVENTION

The present invention provides a method for presenting to a user of an electronic device via a display screen of the electronic device visual feedback of a user interaction, when the device is at a limit of a requested function. The method includes detecting a gesture including a user interaction with the electronic device. The gesture is then associated with a function. A determination is then made as to whether the associated function has reached a limit which would preclude execution of the associated function. If the associated function has not reached the limit which would preclude execution of the associated function, then executing the function associated with the detected gesture. If the associated function has reached the limit which would preclude execution of the associated function, then producing an image distortion proximate the user interaction.

In at least one embodiment, the user interaction with the device includes a movement relative to a touch sensitive surface.

The present invention further provides a display interface for presenting visual feedback of a user interaction with an image being presented via an electronic device. The display interface includes a display adapted for visually presenting to the user at least a portion of an image. The display interface further includes a user input adapted for receiving a gesture including a user interaction with the electronic device. The display interface still further includes a controller. The controller is adapted for associating the gesture with a function, determining whether the associated function has reached a limit which would preclude execution of the associated function, and executing the function associated with the detected gesture. If the associated function has not reached the limit which would preclude execution of the associated function, then controller is adapted for executing the function associated with the detected gesture. If the associated function has reached the limit which would preclude execution of the associated function, then the controller is adapted for producing an image distortion proximate the user interaction.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a plan view of an exemplary electronic device incorporating a display interface, such as a touch sensitive display for receiving user gestures, in accordance with at least one embodiment of the present invention;

FIG. 2 is a block diagram of an electronic device incorporating a display interface, in accordance with at least one aspect of the present invention;

FIG. 3 is a plan view of at least a portion of a display for an electronic device illustrating a movement of a pointer corresponding to a gesture proximate an edge where the image being displayed has reached a limit relative to a function associated with the detected gesture;

FIG. 4 is a further plan view of at least a portion of a display for an electronic device illustrating an alternative movement of a pointer corresponding to a further gesture proximate an edge where the image being displayed has reached a limit relative to a function associated with the detected gesture;

FIG. 5 is a still further plan view of at least a portion of a display for an electronic device illustrating a movement of a pair of pointers corresponding to a gesture where the image being displayed has reached a limit relative to a function associated with the detected gesture;

FIG. 6 is a schematic diagram of at least a portion of a display for an electronic device illustrating an alternative movement of a pair of pointers corresponding to a further gesture where the image being displayed has reached a limit relative to a function associated with the detected gesture; and

FIG. 7 is a flow diagram of a method for presenting to a user visual feedback of a user interaction.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated. Furthermore, while the various figures are intended to illustrate the various claimed aspects of the present invention, in doing so, the elements are not necessarily intended to be drawn to scale. In other word, the size, shape and dimensions of some layers, features, components and/or regions for purposes of clarity or for purposes of better describing or illustrating the concepts intended to be conveyed may be exaggerated and/or emphasized relative to other illustrated elements.

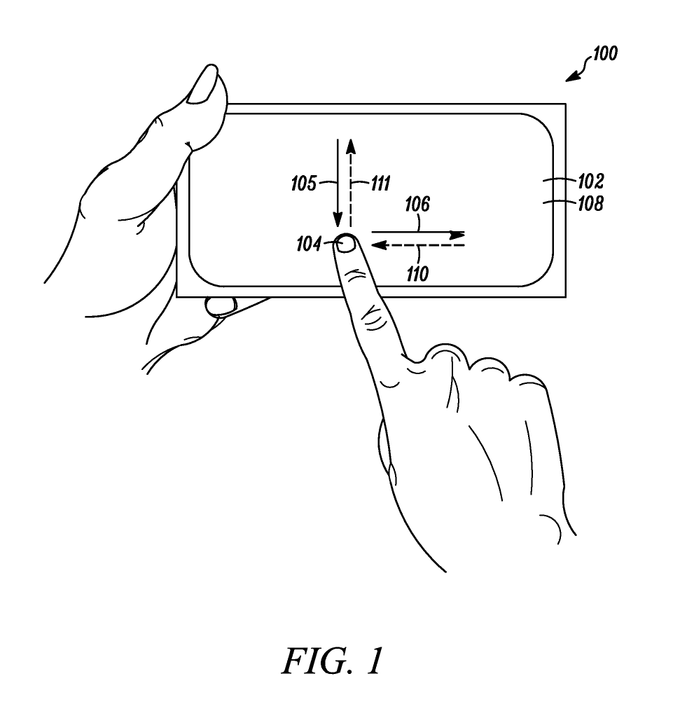

FIG. 1 illustrates a plan view of an exemplary electronic device 100 incorporating a display interface, such as a touch sensitive display for receiving user gestures, and providing visual feedback of the user interaction with the device, in accordance with at least one embodiment of the present invention. The electronic device could be one of many different types of electronic devices including wireless communication devices, such as radio frequency (i.e. cellular) telephones, media (i.e. music) players, personal digital assistants, portable video gaming devices, cameras, and/or remote controls. The present invention is additionally suitable for electronic devices which present an image via a display screen with which the user can interact.

In the illustrated embodiment, the electronic device is a hand-held electronic device, which includes a touch sensitive display 102 upon which a pointer, such as a user's finger 104, can trace a pattern 105 and/or pattern 106, corresponding to a gesture or a portion of a gesture, which can be detected by a user input 108, such as a touch or proximity sensor array and can be interpreted as commands or a requested function. In the illustrated embodiment, the sensor array is formed as part of the display assembly, and/or overlays the display screen in order that an interaction with the display surface can be detected by the device.

Generally, the touch or proximity sensor array can employ various types of touch or proximity sensing technologies including capacitive arrays as well as resistive arrays, the touch sensitive arrays can even employ force sensing resistor arrays, for detecting the amount of force being applied at the selected location. In this way, a force threshold determination can be taken into account in determining the intended interaction including the making of a gesture. However while a touch or proximity sensor array is illustrated, one skilled in the art will readily appreciate that other types of user input could alternatively be used to detect the performance by the user of a gesture that can be used to produce an actionable user selection or input. For example, accelerometers and/or tilt sensors could be used to detect the movement of the device in one of one or more predesignated patterns, which might be recognizable as a user input command, and/or might be associated with a function to be executed by the device. Alternatively, a directional pad, mouse, joystick and/or still other forms of inputs could similarly be used to convey a gesture that can be detected as a valid user input.

In some instances a particular controllable interface, such as the user input 108 may be responsive to more than one type of gesture that might produce a related but different effect. For example, a gesture including the repeated writing of a line having a direction and a length might cause a panning or scrolling effect relative to an image being displayed on a display screen. A direction of the line could be used to identify the direction of any associated panning or scrolling. Furthermore, an amount corresponding to the length of the detected line 105 and/or the speed at which the line 105 is traced could be used to adjust a speed and/or the magnitude of the scrolling. While a downward movement 105 could be used to see more of the upper portions of the image, which might currently correspond to a portion of the image not being presently shown on the display screen 102, a movement in the opposite direction 111 (i.e. upward direction) can cause the image to pan or scroll in the opposite direction. Alternatively a movement of a pointer between left and right 106 or 110, can cause the image to be panned or scrolled in a horizontal direction. The tracing of line in a diagonal direction may also be possible for indicating a panning or scrolling in a diagonal direction. Alternatively, the panning or scrolling in a diagonal direction might be facilitated through a combination of both a vertical and a horizontal gesture.

However, it is possible that in some instances there may not be any more of the image to see in the detected direction of the corresponding user gesture. In such an instance the image could be said to have reached its limit relative to the requested function associated with the detected gesture. In such an instance, the display interface in accordance with the present invention will produce an image distortion relative to the direction of the detected gesture and the particular edge of the display at which the image has reached its limit. The resulting visual distortion provides visual feedback to the user that not only has the gesture been detected, but that the execution of the associated function is precluded due to other circumstances, one such circumstance including the image having reached its limit relative to the requested function.

Such a distortion is an alternative to some display interfaces, which in some instances can simply fail to pan or scroll any further in the requested direction. In some instances it may be unclear whether the lack of further panning or scrolling may be the result of the image having reached its limit, or whether the lack of further panning or scrolling may be the result of having failed to properly detect the corresponding gesture. In other instances, the lack of an immediate response may be perceived as a user interface delay, where such delays may be consistent with communication delays associated with retrieving the additional image data via a network connection, such as the Internet, or where other concurrent processor dependent tasks may be loading the processor and correspondingly delaying the update of the image being displayed on the display screen. A further example of a function that has reached its limit includes the display of a list of elements, where the currently displayed portion of the list includes the elements at one of the ends of the list, where there is no further data in the form of elements in the list, which are not already being displayed in the direction that the scrolling or panning has been requested. A still further example of a function that has reached its limit includes a zoom function where the current interface has reached a limit as to whether further zooming in the desired direction is possible or allowed.

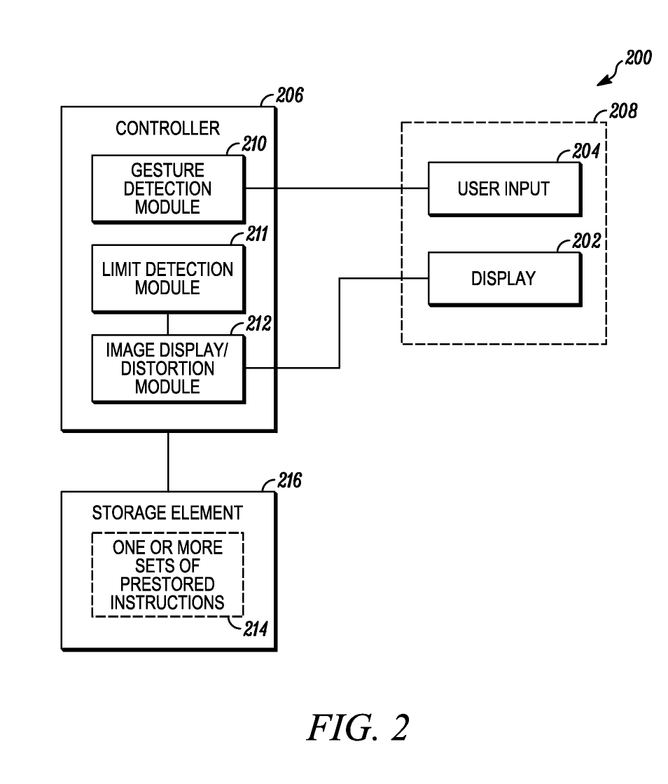

FIG. 2 illustrates a block diagram of an electronic device incorporating a display interface 200, in accordance with at least one aspect of the present invention. The display interface includes a display 202, a user input 204, and a controller 206. The display 202 is adapted for visually presenting to the user at least a portion of an image, where the non-displayed portion of the image can extend in one or more directions beyond the edge of the display screen. The user input 204 is adapted for receiving at least one of multiple different user gestures. As previously noted, the user input could be incorporated as part of a common assembly 208, which similarly includes the display 202. The display 202 and the user input 204 are coupled to the controller 206, which includes a gesture detection module 210, a limit detection module 211, and an image display/distortion module 212. In some embodiments, the controller 206 could be implemented in the form of a microprocessor, which is adapted to execute one or more sets of prestored instructions 214, which may be used to form at least part of one or more controller modules 210, 211 and 212. The one or more sets of prestored instructions 214 may be stored in a storage element 216, which is either integrated as part of the controller or is coupled to the controller 206. It is further possible that the storage element 216 might further include the data associated with an image to be at least partially displayed, a list of items arranged in a sequence, which are similarly intended to be at least partially displayed as part of a group of individually selectable items, or a set of parameters associated with the limits of the corresponding image or list of items.

The storage element 216 can include one or more forms of volatile and/or non-volatile memory, including conventional ROM, EPROM, RAM, or EEPROM. The storage element 216 may still further incorporate one or more forms of auxiliary storage, which is either fixed or removable, such as a harddrive or a floppydrive. One skilled in the art will still further appreciate, that still other further forms of memory could be used without departing from the teachings of the present invention. In the same or other instances, the controller 206 may additionally or alternatively incorporate state machines and/or logic circuitry, which can be used to implement at least partially, some of modules and their corresponding functionality.

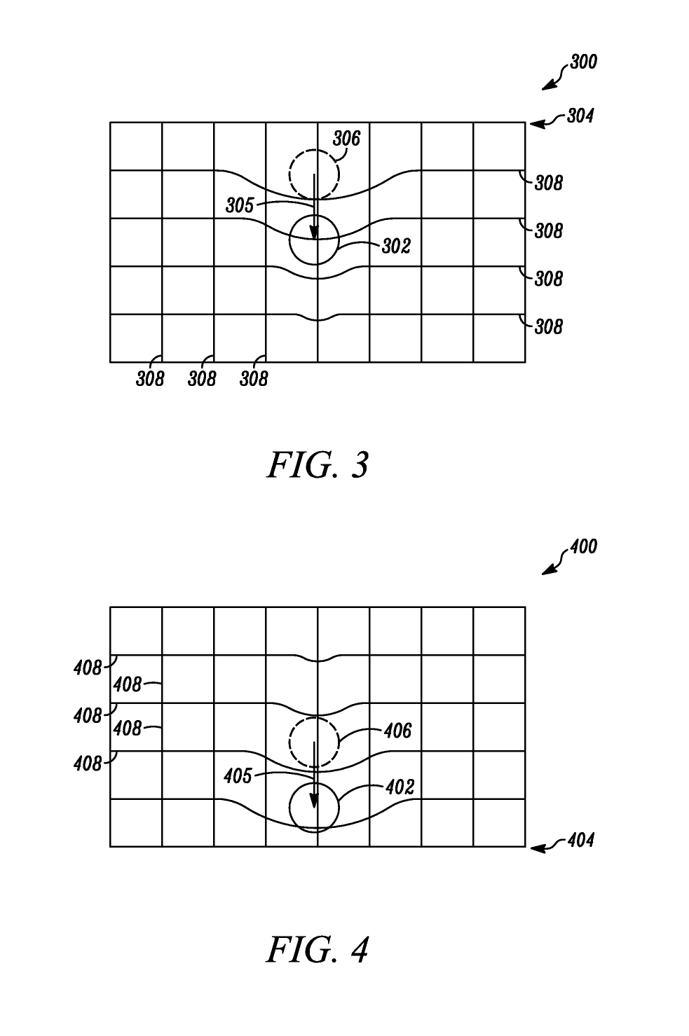

In the illustrated embodiment, the gesture detection module 210 of the controller is adapted to compare a received gesture with one of a plurality of predefined gestures including a plurality of gestures, which are intended to signal a desire to scroll or pan through the image, or group of items, which are arranged in a sequence, such as a menu, and which can be selected by a user. Further gestures may be associated with a desire to zoom in or out relative to the image or items being currently displayed. Upon detection of the particular gesture and the associated function, the limit detection module 211 compares the current display status of the image or the list, and determines whether the function associated with the detected gesture can be performed, or whether the associated function has reached a limit that would preclude its execution.

Where the associated function has not reached the limit which would preclude execution of the associated function, the image display/distortion module 212 then executes the function associated with the detected gesture. Where the associated function has reached the limit which would preclude execution of the associated function, the image display/distortion module 212 causes to be displayed a display image that includes a distortion proximate the user interaction. One such example of an image distortion 300 is illustrated in FIG. 3. In the illustrated embodiment, the image distortion includes a stretching of the display image between the point of user interaction 302 and the portion (or edge 304) of the display for which the displayed image has already reached its limit, as the point of user interaction moves in a direction illustrated by arrow 305 from a starting point having a position corresponding to the circle 306 formed from a dashed line to a point having a position corresponding to the circle 302 formed from a solid line. The image distortion 300 further includes a set of guide lines 308 which highlight how the image has been distorted, where in their undistorted state the guide lines would be substantially evenly space and substantially parallel. A stretching can more readily occur when the point of interaction begins relatively close to the edge portion of the displayed image, which is already at its limit, and the movement of the pointer travels away from that particular edge portion of the image. In addition to the compression between the point of interaction and the particular edge, the distortion 300 can further include a compression, which is located at a position that puts it ahead of the movement of the point of user interaction 302.

As illustrated in FIG. 4, an image distortion 400 in the form of a compression can be more pronounced where the movement of the point of user interaction moves 405 from a point 406 further away from the portion (or edge 404) of the display for which the displayed image has already reached its limit, in a direction that moves the point of user interaction toward a point 402 closer to the portion (or edge 404) of the display for which the displayed image has already reached its limit. In such an instance, the distortion 400 can further include a corresponding stretching behind the movement of the point of user interaction.

Such a distortion can be understood by the user as being indicative that the function associated with a particular gesture has been properly detected, but that because the associated function is already at its limit relative to the displayed image, that further execution of the associated function is precluded. The illustrated distortion is intended to go away or snap back, when the point of user interaction 402 is released, through a disengagement of the pointer relative to the user input, such as the touch sensitive surface 108, see FIG. 1.

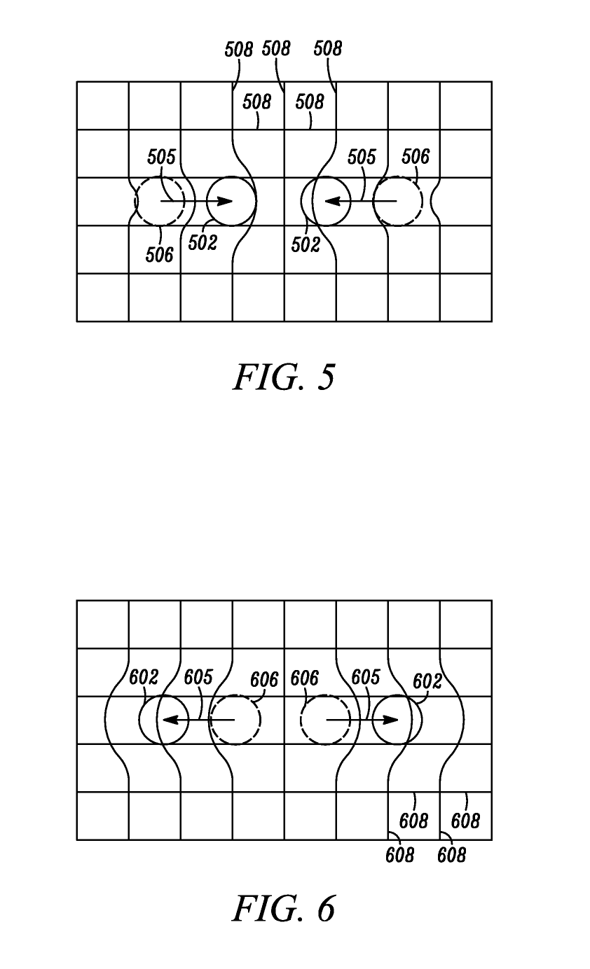

Such a distortion is similarly possible in instances where a gesture might have multiple points of user interaction. Both FIGS. 5 and 6 illustrate alternative examples of image distortion in instances where a pair of points of contact are used in forming a detectable gesture. For example, a particular user interaction can include producing a pinching motion (FIG. 5), which can sometimes be associated with a desire to zoom out, or alternatively where a pair of points of contact are spread apart (FIG. 6), which can sometimes be associated with a desire to zoom in. Similar to FIGS. 3 and 4, dashed circles 506 and 606 represent the detected position of a pair of points of interaction or contact prior to their respective movement (i.e. pinching or spreading). The respective movement is highlighted by arrows 505 and 605, and the position of the pair of points of interaction after their respective movement are represented by solid circles 502 and 602. As the pinching motion between the points of user interaction occurs, in absence of an ability to further zoom out (where the function has reached its functional limit), an image distortion as highlighted by the illustrated guide lines 508 in FIG. 5 will occur. In the illustrated example, the pinching motion produces a compression between the points of user interaction 502. Behind the pinching motion for each of the points of user interaction, a slight stretching can also occur.

Alternatively, FIG. 6, where the points of user interaction 602 are moved 605 further apart, if the corresponding function (i.e. zooming in) has reached the limit which would preclude further execution of the function associated with the gesture, an image distortion in the form of a stretching can occur between the points of user interaction. In front of the spreading motion, a distortion in the form of a compression can also occur. The guidelines 608 help highlight the resulting distortion in the particular embodiment illustrated. Absent the above noted distortion, the guidelines 608 would be generally spaced evenly apart, and would be substantially parallel.

In each of the above noted examples, the image distortion serves to confirm to the user that both the gesture was detected, and that associated function has reached one or more limits which precludes the execution of the function as expected. In this way, the user is not left wondering the reason that the device has not yet or might have failed to execute the function as expected. The visual feedback even in instances where execution of the function is precluded conveys more detailed information to the user in a relatively unintrusive manner.

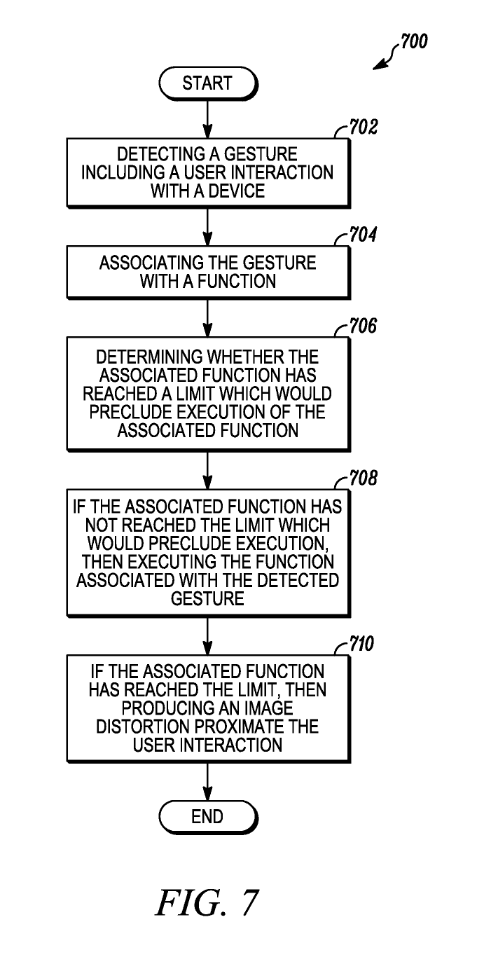

FIG. 7 illustrates a flow diagram of a method 700 for presenting to a user of an electronic device via a display screen of the electronic device visual feedback of a user interaction, when the device is at a limit of a requested function. The method 700 includes detecting 702 a gesture including a user interaction with the electronic device. The gesture is then associated 704 with a function. A determination 706 is then made as to whether the associated function has reached a limit which would preclude execution of the associated function. If the associated function has not reached the limit which would preclude execution of the associated function, then executing 708 the function associated with the detected gesture. If the associated function has reached the limit which would preclude execution of the associated function, then producing 710 an image distortion proximate the user interaction.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for presenting to a user of an electronic device via a display screen of the electronic device visual feedback of a user interaction, when the device is at a limit of a requested function, the method comprising:
detecting a gesture including a user interaction with the electronic device;
associating the gesture with a function;
determining whether the associated function has reached a limit which would preclude execution of the associated function;
wherein if the associated function has not reached the limit which would preclude execution of the associated function, then executing the function associated with the detected gesture; and
wherein if the associated function has reached the limit which would preclude execution of the associated function, then producing an image distortion proximate the user interaction.

2. A method in accordance with claim 1, wherein the user interaction with the device includes a movement relative to a touch sensitive surface.

3. A method in accordance with claim 2, wherein the movement relative to the touch sensitive surface includes a detection of a proximity of an end of a pointer at different points of time relative to different portions of the touch sensitive surface.

4. A method in accordance with claim 2, wherein the movement relative to the touch sensitive surface includes a detection of a force of an end of a pointer at different points of time applied to different portions of the touch sensitive surface.

5. A method in accordance with claim 1, wherein the user interaction includes a single pointer having a single point of contact.

6. A method in accordance with claim 5, wherein the image distortion includes an elastic response of a portion of an image being presented via the display screen proximate the single point of contact.

7. A method in accordance with claim 6, wherein the elastic response extends between the single point of contact and an edge of the display screen corresponding to a location of the limit relative to the requested function.

8. A method in accordance with claim 6, wherein the elastic response includes a stretching of the image.

9. A method in accordance with claim 6, wherein the elastic response includes a compressing of the image.

10. A method in accordance with claim 1, wherein the user interaction includes multiple pointers having multiple respective points of contact.

11. A method in accordance with claim 10, wherein the image distortion includes an elastic response of a portion of an image being presented via the display screen between the multiple respective points of contact.

12. A method in accordance with claim 1, wherein the function includes scrolling through a list of items.

13. A method in accordance with claim 1, wherein the function includes panning an image to display a different portion of the image, where the edge of the image extends beyond the edge of the display screen in at least one direction.

14. A method in accordance with claim 1, wherein the function includes a zooming of the image, where a different amount of the image is displayed via the display screen.

15. A display interface for presenting visual feedback of a user interaction with an image being presented via an electronic device, the display interface comprising:
a display adapted for visually presenting to the user at least a portion of an image;
a user input adapted for receiving a gesture including a user interaction with the electronic device; and
a controller adapted for associating the gesture with a function, determining whether the associated function has reached a limit which would preclude execution of the associated function, and executing the function associated with the detected gesture;
wherein if the associated function has not reached the limit which would preclude execution of the associated function, then the controller is adapted for executing the function associated with the detected gesture; and wherein if the associated function has reached the limit which would preclude execution of the associated function, then the controller is adapted for producing an image distortion proximate the user interaction.

16. A display interface in accordance with claim 15, where the user interface is a touch sensitive surface.

17. A display interface in accordance with claim 16, where the touch sensitive surface is integrated as part of the display.

18. A display interface in accordance with claim 15, where said electronic device is a hand-held electronic device.

19. A display interface in accordance with claim 18, where the electronic device is a wireless communication device.
